(19) United States
(12) Patent Application Publication
(10) Pub. No.: US 2006/0275038 A1
(43) Pub. Date: Dec. 7, 2006

(54) Methods and apparatus for selective signal amplification

(76) Inventors: Donnell T. Walton, Painted Post, NY (US); Aleksandra Boskovic, Elmira, NY (US); Alan F. Evans, Beaver Dams, NY (US); Alranzo B. Ruffin, Painted Post, NY (US)

Correspondence Address: CORNING CABLE SYSTEMS LLC, P O BOX 489, HICKORY, NC, 28603, US

(21) Appl. No.: 11/143,841

(22) Filed: Jun. 2, 2005

(51) Int. Cl. H04J 14/00

(52) U.S. Cl. 398/71

(57) ABSTRACT

A module for use in a passive optical network including a single coil of erbium and a passive optical splitter, whereby digital and analog signals pass through the module from a central office/head end and a subscriber premise, while only the analog signal passes through the single coil of erbium for signal amplification.

### CROSS-REFERENCE TO RELATED APPLICATIONS

This application is related to U.S. patent application Ser. No. entitled “METHODS AND APPARATUS FOR MULTIPLE SIGNAL AMPLIFICATION” filed contemporaneously and which is hereby incorporated in its entirety by reference.

### BACKGROUND OF THE INVENTION

1. Field of the Invention

The present invention relates generally to a passive optical network, and more specifically, to a passive optical network module for selective signal amplification.

2. Technical Background

Passive optical networks (PONs) are used to provide high- bandwidth information to and from an end user or subscriber of the metropolitan area network. Typically, PONs are fiber-based, tree architecture networks with one or two levels of passive splitting providing a total split ratio up to thirty-two, which provides for some cost sharing of the expensive broadcast and digital downstream equipment. Existing PONs have about a 20 kilometer (km) reach with dedicated fiber drops to every subscriber premises, shared TDMA (timed division multiple access) upstream at a different wavelength, and, by definition, no electrical power in the outside fiber plant. While PONs are in use, they have not been widely commercially deployed because of a high cost per subscriber and the low rate of return for the telecommunications service provider or carrier. Based on increases in demand for high bandwidth and interactive services over bi-directional links, there is a renewed interest in PONs from telecommunications service providers for multiple reasons. First, new applications such as file sharing and software downloads require much higher connection speeds than the current digital subscriber line (DSL) technology can provide. Second, there is strong competition for services from cable television (CATV) companies, which already have a majority of the broadcast TV market and offer similar quality internet connections and telephony services. For telecommunications service providers to remain competitive, it would be desirable to provide a technology and a network that can surpass the bandwidth of CATV's hybrid fiber-coax to provide a subscriber with all desired services, some of which include TV, POTS (plain old telephone service) and internet connection.

Fiber-to-the-home (FTTH), fiber-to-the-business (FTTB) and fiber-to-the-premises (FTTP), referred to generically as FTTx, is just such a technology. Telecommunication service providers are attempting to standardize a FTTx PON solution to drive equipment prices to levels that offer an acceptable return on investment. Current subscriber equipment costs are in the thousands of dollars even with the 32-way sharing from single or two-stage splitting. The present invention addresses the sharing of costs issue by considering outside-plant amplification without outside-plant electrical powering. Amplification improves the total optical power loss in a system, referred to as the “loss budget”, and allows additional splitting and/or increased transmission distance, thereby distributing more of the infrastructure costs, especially the head end electronics and optics, over more subscribers. With the existing distribution of central offices (COs), increased distance may not be required, but consolidating several COs into one increases the typical transmission distance while improving equipment utilization especially important at low penetration rates.

Various modes of amplification in PONs have previously been proposed and are known in the literature. However, a mode of amplification is needed that lowers the amplification costs to improve the cost savings from additional equipment sharing.

### SUMMARY OF THE INVENTION

One aspect of the invention is a module employed in a passive optical network (PON), wherein the module includes a single coil of erbium and a passive optical splitter whereby multiple signals pass through the module from the CO/head end and the subscriber, while only the analog broadcast signal passes through the erbium coil contained within the module.

In another aspect, the present invention provides a FTTx PON including a CO/head end including one or more high power pumps, a wavelength division multiplexer/demultiplexer (WDM) system for combining multiple signals, a module including a single coil of erbium and passive optical splitters whereby multiple signals pass through the module while only the analog broadcast signal passes through the erbium coil, a local convergence point (LCP) and one or more network access points (NAP) for providing fiber drops to a plurality of subscriber locations. In alternative embodiments, the module may include an optional isolator for protecting the erbium coil from reflections from the subscriber premise equipment. In preferred embodiments, the FTTx PON including the module provides 1×32 splitting at the LCP and 1×4 splitting at the NAPs, thus providing 128 splits and about a 20 km network reach. In contrast, conventional PONs provide 1×4, 1×8 or 1×16 splitting at the LCP and 1×4 splitting at the NAPs for a maximum of up to 32 splits and up to a 20 km reach, but not both together. In preferred embodiments, the erbium coil is positioned medially between the CO/head end and the LCP, in more preferred embodiments, the module is positioned immediately before the LCP splitter.

In yet another aspect, the present invention provides an amplifier/splitter package adjacent to an LCP in a passive optical network. In a preferred embodiment, the package includes a single coil of erbium and a passive optical splitter whereby multiple signals pass through the package from the CO/head end and the subscriber, while only the analog broadcast signal passes through the erbium coil. Within the package, the digital downstream signal is separated from and recombined with the analog signal by way of a plurality of WDMs. The analog and digital signals are preferably split 1×32 at their first split point at the LCP. In further embodiments, for additional splitting or longer network reach, additional gain may be achieved by semiconductor optical amplifiers (SOAs) in the CO/head end. The SOAs operate as a booster amplifier for the digital downstream and as a pre-amplifier for the digital upstream. Various embodiments with respect to specific pump sharing configurations, optimum range of noise figures, coil length, pump power, gain and gain flatness are provided.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof. Additionally, the drawings and descriptions are meant to be illustrative and not limiting.

### BRIEF DESCRIPTION OF THE DRAWINGS

FIG. 1 is a block diagram illustrating a portion of a PON including an amplification/splitter module containing a single coil of erbium and a passive optical splitter.

FIG. 2 is a block diagram of a FTTx PON illustrating the location of a pump in the CO/head end and the erbium coil immediately before the LCP splitter.

FIG. 3 is a block diagram illustrating a FTTx PON with 128 splits and a 20 km reach where a coil of erbium is placed in the LCP, thereby increasing the LCP split ratio.

FIG. 4 is a block diagram illustrating one embodiment of a pump sharing configuration in which a single high power pump is split between two PONs.

FIG. 5 is a block diagram illustrating an alternative embodiment of a pump sharing configuration in which two lower power pumps are shared between two PONs.

FIG. 6 is a block diagram illustrating a preferred embodiment of the CO/head end including SOAs and a polarization multiplexer (PMUX).

### DETAILED DESCRIPTION OF THE PREFERRED EMBODIMENTS

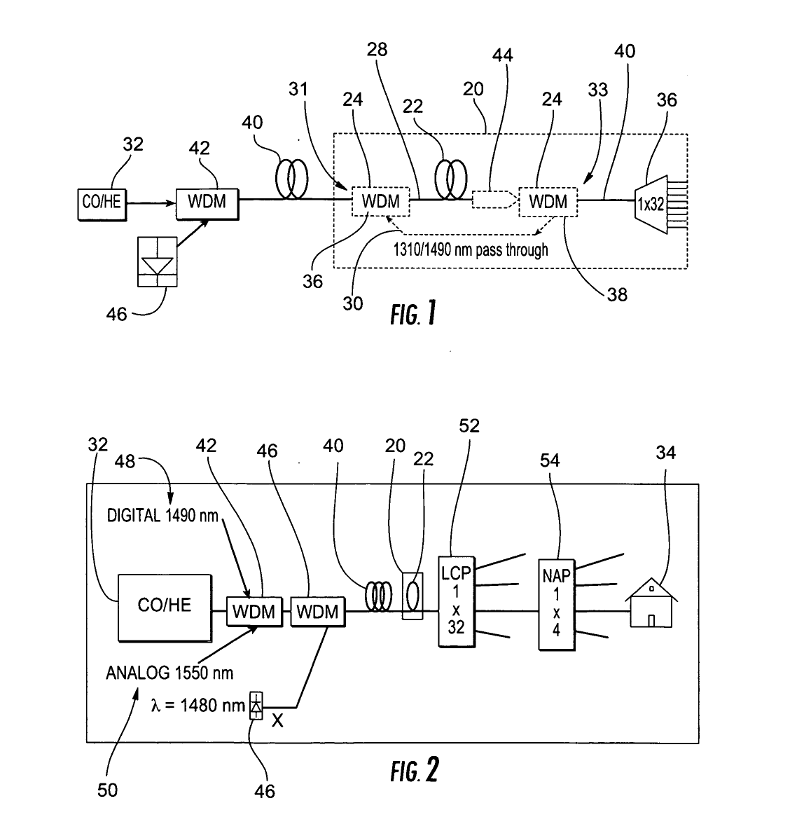

Reference will now be made in detail to exemplary embodiments of the invention, and examples of which are illustrated in the accompanying drawings. Whenever possible, the same reference numerals will be used throughout the drawings to refer to the same or like parts. A module employed in a PON wherein the module includes a coil of erbium and a passive optical splitter whereby multiple signals pass through the module while only a portion of the signals pass through the erbium coil for signal amplification is shown in FIG. 1 and is designated generally throughout by reference number 20.

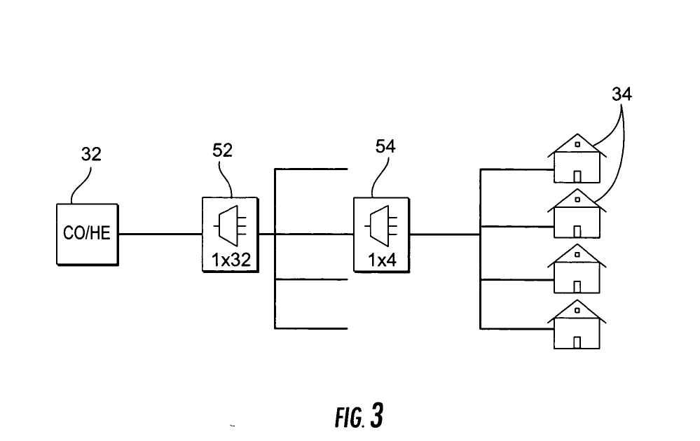

Throughout the detailed description, the current full service access network standard specifies analog downstream between 1550 and 1560 nanometers (nm), digital downstream between 1480 and 1490 nm and digital upstream between 1260 and 1360 nm. The present invention retains these wavelength designations. Referring now to FIG. 1, a portion of a PON including an amplification/splitter module 20 containing a passive amplification element 22 and a pair of wavelength division multiplexers (WDMs) 24 is shown. In one embodiment, passive amplification element 22 is a single coil of erbium and is sometimes referenced as single coil of erbium 22. As used herein, the term “passive amplification element” refers to all things capable of amplifying an optical signal without electricity such as a coil of erbium. In one embodiment, a 1×32 splitter 26 may be a component of the module 20. In some embodiments, the 1×32 splitting occurs in a local convergence point (LCP) (FIG. 2 at reference number 52) downstream of the module 20.

The module 20 architecture includes a first optical branch 28 and a second optical branch 30, wherein the first optical branch 28 includes the single coil of erbium 22. All multiple signals, including analog downstream, digital downstream and digital upstream, pass through the module 20 from the CO/head end 32 and the subscriber 34 (FIG. 2 at reference number 34), while only the analog broadcast signal passes through the first optical branch 28 for amplification. The first and second optical branches 28, 30 are parallel in the sense that the analog signals pass through the first branch 28 while the digital signals pass simultaneously through the second branch 30. Two passive bandpass optical filters, one located at the input end 31 if the module 20, and one located at the output end 33 redirect the digital upstream and downstream signals through the second, alternate path within the amplifier/splitter package.

The first optical branch 28 operates in the 1550 to 1560 nm band of the erbium gain spectrum. The erbium coil 22 acts as an amplifier by exciting weakened analog signals that enter the coil 22. The erbium coil 22 increases the analog signal to compensate for the loss budget of the analog signal that is approximately 3 dB worse than that of the digital signals. In some embodiments, the loss budget for the analog signal is equalized to that of the digital signals by gain provided by the erbium coil 22. In other words, an erbium gain of approximately 3 dB will equalize the loss budget over all three signals.

The downstream digital signals are separated from the downstream analog signal at the first WDM 36, and are later recombined after the erbium coil 22 by the second WDM 38. Upstream digital signals are separated from and later recombined in the reverse order. As stated above, both the first and the second WDMs 36, 38 may be simple low pass filters. Prior to the first module WDM 36, the multiple signals are carried by various wavelengths of light through a single optical fiber 40 through a conventional WDM system 42. The conventional WDM system 42 may include a transmission system that includes a series of transmitters each coupled to a multiplexer. The multiplexer provides an output that is coupled to the optical fiber 40. Although not shown, at the receiving end is a system that includes a demultiplexer and a series of receivers. The optical fiber 40 is also coupled to an input of the demultiplexer of the receiving system. The WDMs transmit the light signals at the appropriate wavelengths and combines the signals for transmission along the optical fiber 40.

The optical fiber may be a SMF-28®, HI 980 or HI 1060 single mode optical fiber available from Corning Cable Systems of Hickory, N.C., which exhibit consistently low splice loss when coupled with an erbium-doped fiber. Gain-flattening filters (GFF) are not needed due to the fact that the 1550 to 1560 nm bandwidth is sufficiently flat. An optional isolator 44 may be contained within the module 20 in the first optical branch 28 to protect the erbium coil 22 from reflections from the customer premise equipment.

As stated above, splitting may occur within the module 20, but typically occurs within an LCP after amplification. The LCP is the first splitter from the CO/head end 32 and is typically located between the CO/HE 32 and the one or more network access points (NAPs) (FIG. 2 at reference number 54). In one embodiment, the split rate of the present invention at the LCP is improved to 1×32, versus conventional split rates of 1×4, 1×8 or 1×16 at the LCP. In one embodiment, the module 20 including the erbium coil 22 is located immediately before the LCP at a distance from about 0 to 20 km from the CO/head end 32. The amplifier/splitter module 20 may be included within an enclosure or may be contained within an enclosure including additional network components. The module 20 may also be located within the LCP. In one embodiment, specifications of the remotely-pumped erbium coil 22 include: wavelength from 1550 to 1560 nm (dependent on number of channels); a length from about 5 to 15 m; an optical input from 9 to 13.5 dBm (assuming 15dBm Pin, 1 dB connector loss, 1.25 to 5); gain from 3 to 13 dB (constant gain); gain tilt maximum of 0.5 dB/nm (for CSO<-59); and, noise from 5.0 to 6.7 dB (<0.5 dB ACNR with 6.75 dB). The module 20 provides outside plant amplification without outside plant electrical powering. The wavelengths originating from the one or more 1480 nm pumps 46 remotely excite the erbium coil 22, thus energizing the erbium coil 22 and energizing the analog transmission signal. The energy does not propagate beyond the LCP, but is used to amplify the signal for increased splitting at the LCP. Stimulated Brillouin scattering (SBS) impairs the fidelity of a signal at 1550 nm, but at 1480 nm the fidelity is not important, it is only the optical power. A power output of about 63 to about 100 mW is preferred for a 20 km network, but may vary based on the length of the network and the number of splits. The power range is bounded by the minimal amount to insure a managable SNR and the highest power to avoid the onset of Stimulated Brillouin Scattering (SBS). In an alternative embodiment, a conventional network having 1×4, 1×8 or 1×16 splitting in the LCP may benefit from the principles of the present invention by using an erbium coil and a lower power laser diode to supply power to the same number of subscribers.

Referring now to FIG. 2, a block diagram illustrating an FTTx PON including a 1480 nm pump 46 in the CO/head end 32 and the erbium coil 22 immediately before the LCP splitter 26 is shown. In the embodiment shown, the digital downstream 48 and analog downstream 50 signals have been combined before the pump WDM 46. The CO/head end 32 includes the one or more high power pumps. Typically, WDM system 42 combines the multiple signals and is positioned immediately after the CO/head end 32. The module 20 including a single coil of erbium 22 and a pair of WDMs is disposed between the WDM system 42 and the LCP 52. One or more NAPs 54 are typically disposed between the LCP 52 and the subscriber premises 54. Preferably, when the split rate at the LCP 52 is 1×32, the module 20 is positioned at a distance up to about 20 km from the pump 46 so that the signal level does not drop down to approximately the noise level, a point at which the erbium coil may not be able to distinguish between the noise and the signal.

Referring to FIG. 3, a block diagram illustrating an exemplary FTTx PON with 128 total splits and a 20 km reach where a coil of erbium is placed in the LCP 52 is shown. The coil of erbium 22 increases the LCP split rate and/or increases the network reach. In some embodiments, the FTTx PON provides 1×32 splitting 56 at the LCP and 1×4 splitting 58 at the NAPs, thus providing 128 splits and about a 20 km network reach. In the exemplary FTTx PON shown, the distance between the CO/head end 32 may range from about 0 to 18 km, the distance from the LCP 52 to the individual NAPs 54 may range from about 0 to 4 km, and the dedicated drops from the NAPs 54 to the subscriber premises 34 may range from about 0 to 500 ft, for a total network reach of around 20 km with 128 splits. In the figures, coils of fiber 40 are shown to illustrate that module 20 is distanced from the CO/HE 32 and these coils should not be confused with erbium coils 22.

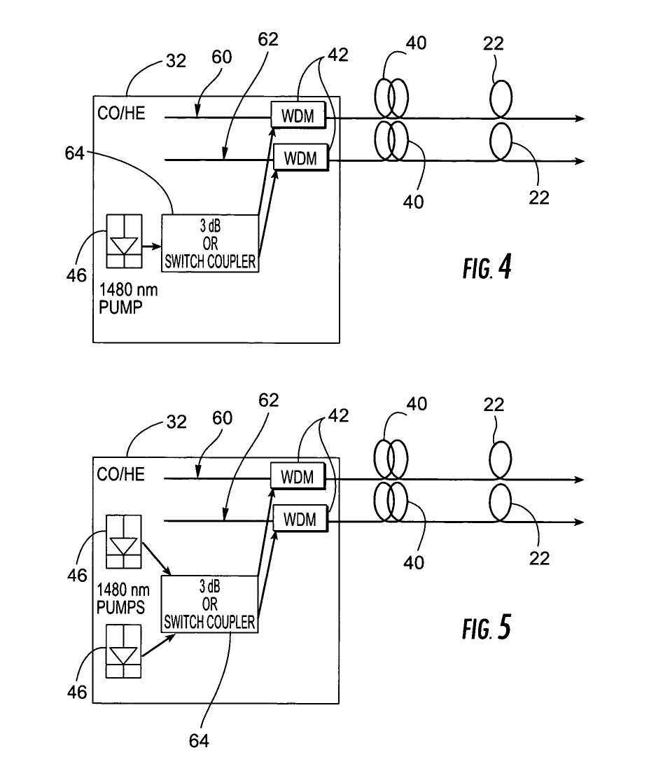

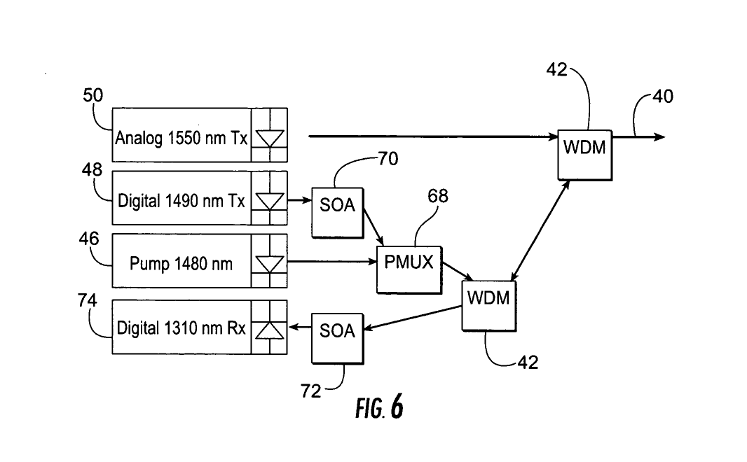

Referring to FIG. 4, a block diagram illustrating a pump-sharing configuration in which a single high power pump laser diode 46 is split between two PONs 60, 62 is shown. A 3 decibel (dB) tap coupler or switch coupler 64 may be used to provide adjustable gain, a useful feature if PON loss is unequal from a difference in fiber distance, split ratio, number of connections, or other reasons. This is especially useful in NAPs with two fiber outputs so that a single pump controls each NAP. As shown in FIG. 2, the erbium coil 22 is positioned within each PON after the CO/head end 32 but before the LCP 52. Referring to FIG. 5, a block diagram illustrating an alternative embodiment of a pump sharing configuration in which two lower power pump laser diodes 46 are shared between two PONs 60, 62 is shown. One benefit with this configuration is increased reliability in case of pump failure. The pump(s) 46 are used to drive the amplifying erbium coil 22 in the analog path. In the two pump 46 configuration, both of the lasers may drive the erbium coil 22 in the analog path. In both configurations, the pump laser diode(s) 46 drives the erbium coil 22 via the switch coupler 64 and respective WDM devices 42. With respect to either pump configuration, the gain or output power to each of the PONs 60, 62 can be controlled independently.

In a further embodiment, the present invention provides an amplifier/splitter package at an LCP 52 in a passive optical network. Preferably, the package includes a single coil of erbium 22 and a passive optical splitter whereby multiple signals pass through the package from the CO/head end 32 and the subscriber, while only the analog broadcast signal passes through the erbium coil. As in the previous embodiments, within the package the digital downstream signal is separated from and recombined with the analog signal by way of a plurality of WDMs. The analog and digital signals are preferably split 1×32 at their first split point at the LCP 52. In this particular embodiment, for additional splitting or longer network reach, additional gain may be achieved by semiconductor optical amplifiers (SOAs) in the CO/head end 32. The SOAs provide a broad gain bandwidth tuned to the digital wavelengths, while the fiber-based erbium amplifier is ideal for the high output power of the analog signal. The SOAs operate as a booster amplifier for the digital downstream and as a pre-amplifier for the digital upstream. An embodiment including SOAs is shown in FIG. 6.

Referring to FIG. 6, a block diagram illustrating one embodiment of a head end including SOAs tuned to the digital wavelengths is shown. The analog and digital signals are all FSAN compliant. Due to their close wavelength spacing, the pump 46 and digital downstream 48 are combined via a polarization multiplexer (PMUX) 68 prior to a WDM 42. The location of the SOA preamp 70 for the digital 1490 nm signal and the SOA booster 72 for the 1310 nm digital upstream signal 74 are shown. Simple bandpass filter functions may be used for the WDMs. The LCP 52 is the local convergence point or the first splitter from the CO/head end 32. Additionally, this solution does not require that the transmitter within the customer premise triplexer be bandwidth restricted. The more limited bandwidth of erbium compared to SOAs forces a Distributed FeedBack (DFB) or Vertical Cavity Surface Emitting Laser (VCSEL) transmitter to maintain the signal gain over temperature.

Referring to Tables 1(a) and (b), the effect of the amplifier noise figure on digital optical signal to noise ratio (OSNR) is shown, wherein Table 1(a) is the digital downstream and Table 1(b) is the digital upstream. An OSNR of 2.1 dB corresponding to a Q of 8.5 dB is sufficient at 622 Mb/s data rate. The erbium gain bandwidth is between 1550 and 1560 nm. This is a flat part of the emission spectrum so no additional gain flattening filter is needed. The SOAs have a broader bandwidth than erbium, which enables the use of uncooled Fabry-Perot (FP) laser diodes

With respect to SOA noise figures, assuming only one amplifier and a low data rate, the noise figure does not set a tight requirement on digital transmission performance. The relatively high noise figure of typical SOAs is sufficient. However, it is preferred that the analog noise figure stay below 6.7 dB for less than 0.5 dB carrier-to-noise ratio degradation. Erbium fiber amplifiers may achieve this if pump power is properly specified. Thus, the hybrid amplifier configuration described above provides sufficient performance for access networks and stays within the designated FSAN wavelengths. The SOAs provide a broad gain bandwidth tuned to the digital wavelengths while fiber-based erbium amplifiers are ideal for the high output power of the analog signal. Typical noise figures will not impair the transmission. For future cost reduction, the SOAs may be integrated into the transmitter or receiver.

One benefit of amplifying the analog signal with an erbium coil prior to the LCP is boosting signal strength for increased splitting, which leads to cost reduction. The remote amplification in the outside fiber plant of a PON avoids stimulated Brillouin scattering of the analog signal while spreading expensive shared equipment costs over more subscribers. Today, a nearly SBS-limited signal power is launched at the CO/head end to maximize the analog signal power budget. Remote amplification allows the signal power to drop in the fiber plant before gain is added, just before the splitter. The gain adds to the power budget allowing increased loss from more optical splitting, more fiber or more connectors. Given today's architectures and the cost of components, increased optical splitting provides the greatest costs savings, increasing to at least 1×128 splitting from 1×16 for subscribers out to 8 km from the CO/head end, and 1×32 for subscribers between about 8 to 20 km from the CO/head end. The required additional gain, about 7 dB, is cost effectively achieved with a remotely pumped erbium coil. Any future upgraded transmitter speed increase could be accommodated by an upgrade of the amplifier gain.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A module for use in a passive optical network, comprising:
a single coil of erbium; and
a passive optical splitter;
whereby digital and analog signals pass through the module from a central office/head end and a subscriber premise, while only the analog signal passes through the single coil of erbium for signal amplification.

2. The module according to claim 1, wherein the digital and analog signals are full service access network standard compliant and analog downstream is defined between 1550 and 1560 nm, digital downstream between 1480 and 1490 nm and digital upstream between 1260 and 1360 nm.

3. The module according to claim 1, further comprising an isolator operable for protecting the single erbium coil from reflections from subscriber premise equipment.

4. The module according to claim 1, wherein the passive optical splitter includes a first bandpass optical filter positioned at an input end of the module and a second bandpass optical filter positioned at an output end of the module, wherein the first and second bandpass optical filters are operable for redirecting digital downstream and digital upstream signals through an alternate path within the module separate from the analog signal.

5. The module according to claim 1, wherein an erbium gain of about 3 dB is applied to the analog signal by the single coil of erbium.

6. The module according to claim 1, wherein additional gain is achieved using one or more semiconductor optical amplifiers located in the central office/head end operable for amplifying the digital downstream signal and pre-amplifying the digital upstream signal.

7. The module according to claim 1, wherein the module is positioned within the passive optical network immediately before a local convergence point.

8. The module according to claim 7, wherein the amplification of the analog signal by the single coil of erbium allows for a split rate of 1×32 at the local convergence point in the passive optical network.

9. A passive optical network, comprising:
a central office/head end for originating digital and analog signals;
a local convergence point functioning as a first split point in the passive optical network for splitting the digital and analog signals;
a subscriber premise; and
a module located between the central office/head end and the local convergence point, the module containing a coil of erbium and passive optical splitter whereby the digital and analog signals pass through the module from the central office/head end and the subscriber premise while only the analog signal passes through the coil of erbium contained within the module.

10. The passive optical network according to claim 9, wherein the module defines first and second optical branches, the first optical branch including the coil of erbium for amplifying only the analog signal and the second optical branch for re-directing the digital signals through an alternate path within the module.

11. The passive optical network according to claim 9, wherein the coil of erbium amplifies the analog signal within the 1550 to 1560 nm band.

12. The passive optical network according to claim 9, wherein the coil of erbium provides a gain sufficient to equalize the loss of the digital and analog signals.

13. The passive optical network according to claim 9, wherein the passive optical splitter includes a first bandpass optical filter positioned at an input end of the module and a second bandpass optical filter positioned at an output end of the module, wherein the first and second bandpass optical filters are operable for re-directing the digital signals.

14. The passive optical network according to claim 9, wherein the module provides gain in the analog signal sufficient to allow 1×32 splitting of the digital and analog signals in the local convergence point and 1×4 splitting in downstream network access points for a total split rate of 128 splits and/or a 20 km reach of the network.

15. The passive optical network according to claim 9, further comprising one or more semiconductor optical amplifiers in the central office/head end for amplifying digital downstream signals and pre-amplifying digital upstream signals.

16. The passive optical network according to claim 9, wherein the module is positioned immediately before split points in the optical network to amplify the analog signal.

17. The passive optical network according to claim 9, wherein the coil of erbium ranges from about 5 to 15 m in length.

18. The passive optical network according to claim 9, wherein the central office/head end includes a single pump split between two passive optical networks, and a switch coupler for providing adjustable gain when passive optical network loss is unequal resulting from a distance in fiber distance, split ratio or number of connectors.

19. The passive optical network according to claim 9, wherein the central office/head end includes two pumps shared between two passive optical networks through a single switch coupler.

20. A passive only network wherein amplification of less than all signals occur through a module containing a passive amplification element and a passive optical splitter, whereby multiple signals pass through the module from a head end and subscriber while less than all signals pass through the passive amplification element contained within the module.
